(19) United States
(12) Patent Application Publication
(10) Pub. No.: US 2023/0140595 A1
(43) Pub. Date: May 4, 2023

(54) SYSTEMS AND METHODS TO EFFICIENTLY INTEGRATE PROCESSING SERVICE REQUESTS INTO A WEBPAGE

(71) Applicant: Copilot Travel, Inc., Franklin, TN (US)

(72) Inventor: Gary Robert SOMERHALDER, JR., Spring Hill, TN (US)

(73) Assignee: Copilot Travel, Inc., Franklin, TN (US)

(21) Appl. No.: 17/720,709

(22) Filed: Apr. 14, 2022

Related U.S. Application Data
(63) Continuation of application No. 17/519,419, filed on Nov. 4, 2021.

(51) Int. Cl. G06F 16/958; H04L 67/53; G06F 16/2457; G06F 16/9538; G06F 16/955; G06F 16/25; G06F 3/14

(52) U.S. Cl. CPC G06F 16/986; H04L 67/20; G06F 16/24578; G06F 16/9538; G06F 16/9566; G06F 16/258; G06F 3/14

(57) ABSTRACT

In some embodiments, a method can include sending a set of information requests for a set of information associated with a service request. The service request can be received via a widget integrated into a document object model (DOM) of a website associated with a first Uniform Resource Locator (URL). The service request can include an indication of request type, and at least one of an indication of time or an indication of location. The method can further include processing the set of information to produce service results responsive to the service request. The method can further include accessing a content developer network (CDN) to obtain a template for the widget. The method can further include causing an end-user compute device to display the service results based on the template and without constructing a second URL.

### CROSS-REFERENCE TO RELATED APPLICATION

This application claims priority to and is a continuation application of U.S. patent application Ser. No. 17/519,419, filed Nov. 4, 2021 and titled “Systems and Methods to Efficiently Integrate Processing Service Requests into a Webpage”, which is herein incorporated by reference in its entirety.

### TECHNICAL FIELD

The present disclosure relates to the field of computer network communication systems, and in particular to methods and apparatus for efficiently integrating processing service requests into a server system and producing service results in response to the service requests.

### BACKGROUND

Some methods for processing information about service requests and/or search requests of users involve a series of separate data transmissions to multiple sources. That can result in slow, unclear, and/or inconsistent responses to the service requests and can furthermore expose the users to a variety of cybersecurity risks. Thus, a need exists for computer network communication systems and methods that can securely and efficiently produce search results in response to a search request.

### SUMMARY

In some embodiments, a method can include sending a set of information requests for a set of information associated with a service request. The service request can be received via a widget integrated into a document object model (DOM) of a website associated with a first Uniform Resource Locator (URL). The service request can include an indication of request type, and at least one of an indication of time or an indication of location. The method can further include processing the set of information to produce service results responsive to the service request. The method can further include accessing a content developer network (CDN) to obtain a template for the widget. The method can further include causing an end-user compute device to display the service results based on the template and without constructing a second URL.

### BRIEF DESCRIPTION OF THE DRAWINGS

FIG. 1 is a block diagram of a service search environment, according to an embodiment.

FIG. 2 is a flowchart of a method of processing a service request and producing service results in response to the service request, according to an embodiment.

FIG. 3 is a flowchart of a method of processing and presenting a service request via a widget integrated into a document object model (DOM) of a website, according to an embodiment.

FIG. 4 is a flow diagram of processing a service request and producing service results in response to the service request in a service search environment, according to an embodiment.

### DETAILED DESCRIPTION

Non-limiting examples of various aspects and variations of the embodiments are described herein and illustrated in the accompanying drawings.

One or more embodiments described herein generally relate to apparatus, systems and methods for producing service results in response to a service request. The apparatus, systems and methods described herein can automatically process a high number of orders or requests in an expedited fashion and consecutively at a lower cost. For example, the apparatus, systems and methods described herein can perform multiple service request/queries using a single line of code in a widget of a webpage loaded in an end-user compute device to cause a server system to conduct multiple searches, generate search results, and transmit the search results to the end-user compute device. Therefore, the apparatus, systems and methods described herein can reduce time and security risks associated with opening multiple URLs, and improve customer search (e.g., travel search, shopping search, professional services search, etc.) experiences. Otherwise, opening multiple URLS for submitting multiple search queries based on a search request submitted by a user of the end-user compute device would be more time-consuming, error-prone, and could expose the user device to cybersecurity threats. Moreover, the multi-tenant systems and methods described herein can process a high volume of requests from multiple user devices and a high volume of information associated to the requests from multiple third-party service-providers securely and in substantially real-time (e.g., 100 milliseconds, 500 milliseconds, 1 second, etc.).

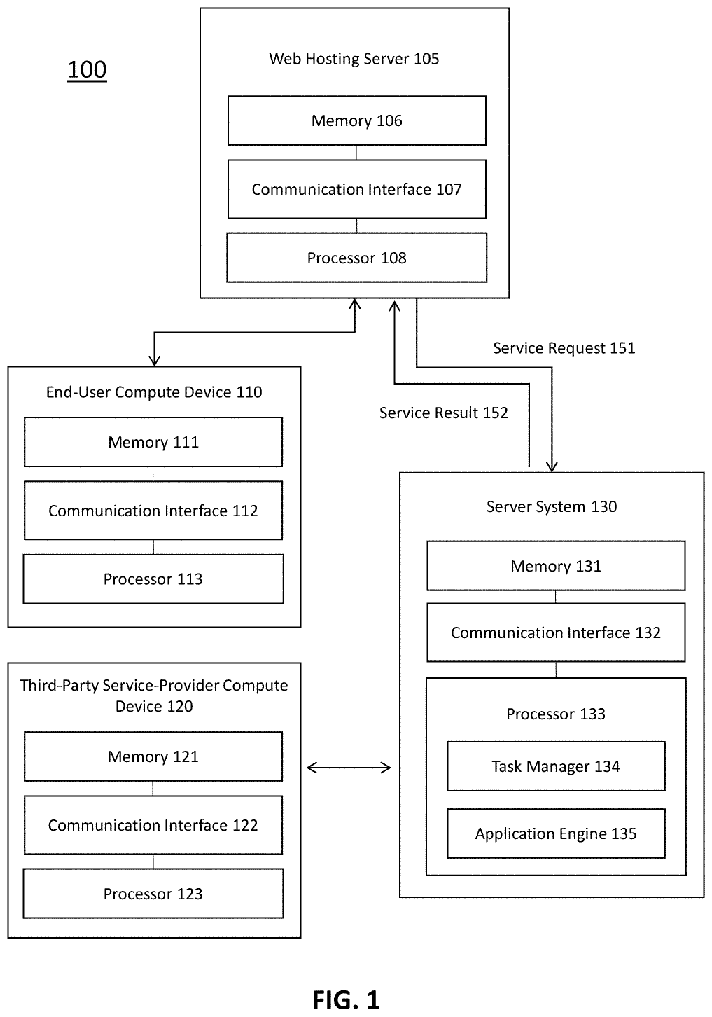

FIG. 1 is a block diagram of a service search environment 100, according to an embodiment. The service search environment 100 can include a web hosting server 105, an end-user compute device 110, a third-party service-provider compute device 120, and a server system 130, that can automatically and scalably produce service results 152 in response to a service request 151. The web hosting server 105, the end-user compute device 110, the third-party service-provider compute device 120, and the server system 130, each can be/include a hardware-based computing device(s) and/or a multimedia device(s), such as, for example, a computer(s), a server(s), a desktop device(s), a laptop(s), a smartphone(s), and/or the like.

The end-user compute device 110 can include a memory 111, a communication interface 112, and a processor 113. The memory 111 (e.g., a random-access memory (RAM), a hard drive, a flash drive, and/or the like) of the end-user compute device 110 can store data (e.g., a service request(s) 151, a service result(s) 152, end-user data, and/or the like), and/or code that includes instructions to cause the processor 113 to perform one or more processes or functions (e.g., send the service request 151 via the web hosting server 105 to the server system 130). The communication interface 112 (e.g., a network interface card (NIC), a Wi-Fi® transceiver, a Bluetooth® transceiver, and/or the like) of the end-user compute device 110 can be a hardware component that facilitates data communication between the end-user compute device 110 and external devices (e.g., the third-party service-provider compute device 120, the server system 130, or the web hosting server 105). The processor 113 (e.g., a central processing unit (CPU), a graphics processing unit (GPU), and/or the like) can be, for example, a hardware-based integrated circuit (IC) or any other suitable processing device configured to run or execute a set of instructions or a set of codes. The end-user compute device 110 can transmit data (e.g., the service request 151), via the web hosting server 105 to the third-party service-provider compute device 120 and/or to the server system 130 and receive data (e.g., service result(s) 152), via web hosting server 105, from the third-party compute device 120 and/or from the server system 130.

The third-party service-provider compute device 120 includes a memory 121, a communication interface 122 and/or a processor 123 that are structurally and/or functionally similar to the memory 111, the communication interface 112 and/or the processor 113 as described with respect to the end-user compute device 110. The third-party service-provider compute device 120 can receive data including, for example, a set of information requests and/or send data including, for example, a set of information. The third-party service-provider compute device 120 can include software that can perform a search based the set of information requests (e.g., an information request(s) for availability and price of flights from a first location to a second location in a time interval and/or in a price range) and generate the set of information in response to the set of information requests. The set of information can be/include, for example, a list of available flight options indicating a third location that is the same as or in proximity of the first location, a fourth location that is the same as or in proximity of the second location, one or more time indicators within the time interval, one or more price options within the price range, and/or the like. While shown in FIG. 1 as including a single third-party service-provider compute device, in some implementations any number of third-party server-provider compute devices and/or systems can be queried for a set of information.

The web hosting server 105 includes a memory 106, a communication interface 107 and/or a processor 108 that are structurally and/or functionally similar to the memory 111, the communication interface 112 and/or the processor 113 as described with respect to the end-user compute device 110. The web hosting server 105 can receive, present and/or send data including, for example, the service request(s) 151, the service result(s) 152, a set of templates, a HyperText Markup Language (HTML) document, a widget, and/or the like. The web hosting server 105 can include software that can include a control panel that can include, for example, a graphical interface for managing websites, databases, files, emails, and/or the like, which are hosted on the web hosting server 105 from a centralized location. In some implementations, the end-user compute device 110 can access a website hosted by the web hosting server 105.

The server system 130 can include one or more compute device mediums particularly suitable for data storage and/or one or more compute device mediums particularly suitable for data processing. For example, the server system 130 can include multiple databases, compute devices, and/or high-performance servers that can be at physically separate locations and connected via a network (not shown). The server system 130 can include, for example, a network of electronic memories (e.g., memories of a database in a data center), a network of magnetic memories (e.g., memories of a database in a data center), a server(s), a blade server(s), a network attached storage(s), and/or the like. In some implementations, a medium from the one or more compute device mediums of the server system 130 can include a memory 131, a communication interface 132, and a processor 133 that are structurally and/or functionally similar to the memory 111, the communication interface 112 and the processor 113 as described with respect to the end-user compute device 110. In some implementations, however, the memory 131, the communication interface 132 and/or a processor 133 can be application-specific hardware (e.g., deep learning storage server, parallel computing device, etc.) that are structurally and/or functionally different than the memory 111, the communication interface 112 and the processor 113 as described with respect to the end-user compute device 110.

In some implementations, the memory 131 can be/include a subset of mediums from the one or more compute device mediums that are separate from (e.g., at a location remote from) the processor 133 and/or separate from the remaining mediums from the subset of mediums of the memory 131. In one example the memory can include a first storage at a first location and a second storage at a second location that is remote from the first location. The first storage can store a set of templates and the second storage can store a list of third-party service-provider compute devices including the third-party service-provider compute device 120.

The server system 130 can include software (can also be referred to as a ‘a module(s)’). The processor 113 can execute a task manager 134 and an application engine 135. In some implementations, such module(s) can be implemented in a set of codes representing instructions that can be executed on the processor 113 or a set of processors (e.g., on a high-performance compute device(s) and/or a distributed compute device(s)). In some implementations, the module(s) can be implemented via software (e.g., using processor 113) and/or on specific hardware (e.g., an AISC). The server system 130 can receive a service request 151 from the end-user compute device 110 via the web hosting server 105. The server system 130 can process the service request 151, as described in further detail herein. Moreover, the server system 130 can send information, templates and/or functionality for the widget to the web hosting server 105 such that the web hosting server 105 can present the widget on the end-user compute device 110.

The task manager 134 can be configured to prioritize processing of multiple service requests (e.g., received from multiple end-user compute devices). In one example, the multiple service requests can be timestamped at the task manager 134 and processed in the order received. In another example, the task manager 134 can timestamp the multiple service requests and associate an estimate commission value to each service request and generate a request queue based on the estimate commission value and the time stamp for each service request. Thereafter, the task manager 134 can then process the multiple service requests based on the request queue.

The application engine 135 can be configured to determine, select and/or identify a set of third-party service-provider compute devices including the third-party service-provider compute device 120, based on the indication of request type. For example, in some instances, the memory 131 can store a list of third-party service-provider compute devices, each associated with and providing at least a search service for a request type from a set of request types (e.g., a flight search, a car rental search, a hotel search, a taxi service search, an event search, a movie theater search, a package search, a confirmation for availability of venues, and/or the like). Therefore upon reception of a service request(s) 151 including an indication of a request type, the application engine 135 can determine or select the set of third-party service-provider compute devices from the list of third-party service-provider compute devices based on at least the request type. In some implementations, the set of third-party service-provider compute devices can be determined based on additional criteria such as, for example, a language of the service request(s), prior customer experience reviews/score associated with each third-party service-provider compute device, commission associated with the third-party service-provider compute device, locations and/or times associated with the third-party service-provider compute device, service level associated with the third-party service-provider compute device, and/or the like.

The application engine 135 can be configured to generate a set of information requests based on the service request(s) 151. In some implementations, each information request from the set of information requests can include at least one of the indication of time or the indication of location. In some implementations, each information request from the set of information requests can be generated based on specific requirements of for each third-party service-provider compute device (such as the third-party service-provider device 120) from the set of third-party service-provider compute devices. For example, a first third-party service-provider compute device may require information requests be submitted in a JavaScript Object Notation (JSON) format whereas a second third-party service-provider compute device may require information requests be submitted in an extensible markup language (XML) format. In some implementations, the set of information requests can be formatting and sent to the third-party service-provider compute devices via one or more application programming interfaces (APIs) associated with the third-party service-provider compute devices.

The application engine 135 can be configured to process a set of information to generate/produce the service result(s) 152 responsive to the service request 151. The application engine 135 receives the set of information from the set of third-party service-provider compute devices, including the third-party service-provider compute device 120, and can filter the set of information, standardize the set of information, and/or rank the set of information, as described in further detail herein.

In use, the end-user compute device 110 can transmit a service request(s) 151 (e.g., a search query, a service request(s) 151 to confirm an availability, location, nearby services, and/or the like) to the server system 130. The end-user compute device 110 can send the service request(s) 151 using a widget integrated into a programming interface (e.g., a document object model (DOM)) of a website associated with a Uniform Resource Locator (URL), and via a web hosting server. In some instances, the webpage can include a HyperText Markup Language (HTML) document and is associated with the URL and does not embed any additional HTML documents (e.g., using IFrame for displaying a web page within a web page) to the HTML document. Using the widget integrated into the programming interface can reduce time associated with opening the additional HTML documents associated with multiple URLs at the end-user compute device 110, and consequently, improve customer search (e.g., travel search, shopping search, professional services search, etc.) experiences. Otherwise, opening additional HTML documents associated with multiple URLs in response to the service request(s) can be more time-consuming and error-prone. Because, (1) the additional HTML documents associated with multiple URLs can often have significantly larger file sizes compared to the widget and (2) a set of responses from the additional HTML documents associated with multiple URLs can sometimes take more than a standard or reasonable time, and therefore, can delay responses to the service request(s). Moreover, using the widget integrated into the programming interface can also reduce security risks (e.g., cybersecurity risks, data security risks, etc.) associated with opening the additional HTML documents associated with multiple URLs at the end-user compute device 110. Otherwise, opening additional HTML documents associated with multiple URLs in response to the service request(s) can, in some instances, load unexpected or undesirable elements in the additional HTML documents. In some instances, the webpage associated with the URL can also include a Cascading Style Sheets (CSS) sandbox to treat content of the widget as being from a unique origin.

The server system 130 can determine a set of third-party service-provider compute devices, including the third-party service-provider compute device 120, from a list of known or available third-party service-provider compute devices (also referred to as the “superset of third-party service-providers”), based on the indication of request type and/or the service request(s) 151. The service request(s) 151 can include and/or be associated with one or more keywords, an indication of request type, and at least one of an indication of time or an indication of location. The indication of request type can include, for example, a flight search, a car rental search, a hotel search, an event search, a movie theater search, a taxi service search, a package search, a confirmation for availability of services, a confirmation for availability of venues, a shopping search, a professional services search, a search for nearby services, a search for nearby venues, and/or the like. The indication of location can include, for example, an indication of a country name, an indication of a city name, an indication of an address, an indication of a global positioning system (GPS) location, and/or the like. In some instances, the service request(s) 151 can include an authentication token (e.g., a Globally Unique Identifier (GUID), a password-based authentication, a certificate-based authentication, etc.) that can confirm authenticity of the service request(s) 151. Including the authentication token in each service request 151 can, in some instances, prevent or reduce a swarm flooding cyber security attack(s).

In one example, the service request(s) 151 can include an indication of a set of preferred service-providers associated with a user of the end-user compute device 110. The server system 130 can then determine the set of third-party service-provider compute devices based on the set of preferred service-providers associated with the user. In some instances, the memory 131 of server system 130 can include at least one storage medium, which can be remote from the processor 133 (e.g., a 100 terabytes cloud Structured Query Language (SQL) storage), that can store a large database of known or available third-party service-provider compute devices.

In some instances, the server system 130 can receive multiple service requests from multiple end-user compute devices. In some implementations, the server system 130 can be configured to process a number of service request (e.g., two service requests, 5 service request, 20 service requests, etc.) in parallel. In some instances, however, the multiple service requests received from the multiple end-user compute devices can be more than the processing cores of the server system 130 can handle in parallel. The task manger 134 of the server system 130 can prioritize the multiple service requests. In some instances, the task manager 134 can label each service request with a timestamp and forward the timestamped service request for further processing. In some instances, the task manager 134 can additionally determine or receive an association of each service request to an estimated commission value. Thereafter, the task manager 134 can prioritize the multiple service requests based on the timestamp and the estimated commission value.

The server system 130 can then generate a set of information requests based on the service request(s) 151 and/or the set of preferred service-providers. Each information request from the set of information requests can include the indication of time or the indication of location. The server system 130 can send the set of information requests to the set of third-party service-provider compute devices at a first time. The server system 130 can be configured to receive a set of information within a predetermined time interval since the first time, received from a subset of third-party service-provider compute devices from the set of third-party service-provider compute devices. Other information received from the remaining third-party service-provider compute devices from the set of third-party service-provider compute devices can be bounced, discarded, or stored in an auxiliary data storage.

The application engine 135 of the server system 130 can then process (e.g., filter, standardize, and/or rank) the set of information to produce the service result(s) 152 responsive to the service request(s) 151. In some instances, the application engine 135 can format the set of information based on an information shell to produce a set of standardized information. For example, the information shell can convert units of distances (e.g., meters, miles, etc.) in the set of information to kilometers.

In some instances, the server system 130 can access a content developer network (CDN) to obtain a template for the widget. The template can include a set of fields to display information. For example, in some instances, the template can include a first field to show a brand name, symbol, image, etc. of the third-party service-provider, a second field to display a destination indicator(s), a third field to display a time indicator(s), a fourth field to display a cost indicator(s), and/or the like. The server system 130 can then transmit the service result(s) 152 and/or the template for the widget to the end-user compute device 110 via the web hosting server 105. In some instances, the template can be stored at the server system 130 and provided to the web hosting server 105 from the server system 130.

In some implementations, the template can be dynamic. Similarly stated, in some implementations, the template used by the widget to display information can be dynamically generated (e.g., by the server system 130) at run-time. For example, processor 133 of the server system 130 can include a configuration engine (not shown in FIG. 1) that can receive parameters associated with the template and, using the parameters, generate the template upon each DOM load and/or widget refresh. The parameters can be default system parameters and/or custom parameters provided and/or updated by an administrator (e.g., through an administrator portal). The parameters can be, for example, a layout for the template, fields associated with the template, a theme associated with the template, types of searches associated with the template, images associated with the template, and/or the like. The parameters can be stored in a memory (e.g., memory 131). Upon a DOM load and/or a widget refresh, the configuration engine can access the parameters from the memory and build the template. The template can then be used to present the widget to the end-user compute device 110 via the web hosting server 105. Such a system allows an administrator to dynamically customize and/or update the widget via parameters.

The end-user compute device 110 can receive the service result(s) 152 (e.g., search results, an indication of availability, and/or the like) from the server system 130 in response to the service request(s) 151, in the widget. The service result(s) 152 can include, for example, a printable document file (PDF) report of the service results and supporting data in JavaScript Object Notation (JSON) format. The server system can then be configured to cause (e.g., by sending a signal representing an operation command) the web hosting server and/or the end-user compute device to display (e.g., via a graphical user interface) the service results based on the template. The end-user compute device 110 can then display the service result(s) 152 to the user of the end-user compute device 110 using a web browser that processes the HTML document associated with the URL without accessing any additional URLs (e.g., loaded via an IFrame).

In some implementations, the widget can include various functionality that allows the user to change the display parameters of the widget. For example, the template (static or dynamic) of the widget can provide functionality to the widget to allow a user of the end-user compute device 110 to sort, search, and/or highlight data returned from the server system 130 and displayed with the widget. For example, the widget can provide the user with the functionality to sort the service results 152 provided by the server system 130. In some implementations, any other functionality used to change the display parameters can be implemented by the widget. In some implementations such functionality can be provided as a service result 152 in response to a service request 151 by the widget to the server system 130 to sort (or provide other functionality) to the widget. In such an example, the server system 130 can provide to the widget the service results 152 formatted (e.g., sorted) in a different order based on the service request 151.

In some instances, each user of the end-user compute device 110 included within a set of end-user compute devices (not shown) can have an account stored in the server system 130. The account can be configured (e.g., via a user preference page) to store an account history (e.g., including a search history, a click history, a processing-time history, a realization history, a payment history, a commission history, etc.) associated with each user and/or each end-user compute device 110. Furthermore, each end-user compute device within the set of end-user compute devices (not shown) can contact the server system 130 (e.g., via the website of the web hosting server 105) for generating and sending the authentication token, performing billing updates, and sending configuration parameters to customize a search(es) for that end-user compute device.

As an example, the website and widget provided to the end-user compute device 110 by the web hosting server 105 can be associated with an airline flight search. The end-user compute device 110 can access a website hosted by the web hosting server 105. The web hosting server 105 can access the server system 130 to obtain a template (dynamic or static) for a widget associated with the website. If the template is dynamic, the server system 130 (e.g., using processor 133) can access parameters of the template (e.g., stored in memory 131) to build the template. The template can then be provided to the web hosting server 105 such that the web hosting server 105 can present the widget to the end-user compute device 110 based on the template.

A user can provide an input to the widget at the end-user compute device 110. For example, such input can be selecting a source airport field. Based on the selection, the widget can provide data to the server system 130 via the web hosting server 105. For example, a GPS location of the end-user compute device 110 (and as identified using the widget) can be provided to the server system 130 as a service request 151 to identify nearby airports. The server system 130 can identify and provide a request to one or more third-party service-provider compute devices 120 (e.g., via API calls) used to identify nearby airports based on the service request 151. The third-party service-provider compute devices 120 can provide the server system 130 with the airport codes associated with nearby airports. As a service result 152, the server system 130 can respond by providing a drop-down list of nearby airport codes to be displayed in the widget and formatted by the template (via the web hosting server 105). Similarly, such searches can be additionally performed on other aspects and/or fields in the widget (e.g., destination airport, dates, etc.).

Moreover, in this example, when a user of the end-user compute device 110 selects to perform a flight search (e.g., based on airports and dates input and/or selected by the user), the service request 151 can be provided to the server system 130 with the relevant parameters. The server system can identify and provide a request to one or more third-party service-provider compute devices 120 used to search flights based on the service request 151 and associated parameters. The third-party service-provider compute devices 120 can provide the server system 130 with the relevant flight details. Moreover, additional searches to other third-party service-provider compute devices 120 can be made for other types of information based on the service request 151. For example, a search for airline logo images to be displayed with the various flight details can be made to one or more third-party service-provider compute devices 120 (e.g., via APIs). For another example, a search for flight reviews, on-time data, and/or the like can be made to one or more third-party service-provider compute devices 120 (e.g., via APIs). Thus, multiple different types of data can be retrieved from various third-party service provider compute devices 120 in response to a single service request 151. Moreover, this allows service results 152 to be dynamically constructed for each service request 151. After the information related to the service request 151 has been retrieved, the server system 130 can provide the information as part of a service result 152 such that the information can be presented to the user via the widget and according to the template. Specifically, the flight results, the airline logo images, the flight reviews, the on-time data, etc. can be presented by the widget as formatted by the template. Similar functionality and searches can be performed for any suitable information requested and/or to be presented by the widget.

In some implementations, the end-user compute device 110, the third-party service-provider compute device 120, the web hosting server 105 and/or the server system 130 can communicate data (e.g., the service request(s) 151, the service result(s) 152, and/or the like) via a network (not shown). The network can be or include, for example, a digital telecommunication network of servers and/or compute devices. The servers and/or computes device of the network can be connected via one or more wired or wireless communication networks (not shown) to share resources such as, for example, data storage and/or computing. The wired or wireless communication networks between servers and/or compute devices of the network can include one or more communication channels, for example, a radio frequency (RF) communication channel(s), a fiber optic commination channel(s), and/or the like. The network can be and/or include, for example, the Internet, an intranet, a local area network (LAN), and/or the like.

Although the end-user compute device 110, the third-party service-provider compute device 120, the server system 130, and the web hosting server 105 are shown and described as singular devices and system, it should be understood that, in some embodiments, one or more end-user compute devices, one or more third-party service-provider compute devices, one or more web hosting servers, and/or one or more server systems can be used in the service search environment 100. For example, in some instances, the multi-tenant system 130 can perform a separate process(es) described herein separately for each third-party service-provider compute device from multiple third-party service-provider compute devices (not shown) to produce a set of service results. The separate process(es) for each third-party service-provider compute device can involve, for example, generating an information request specific that has a format specific to that third-party service-provider compute device (e.g., specific to an API of that third-party service-provider compute device).

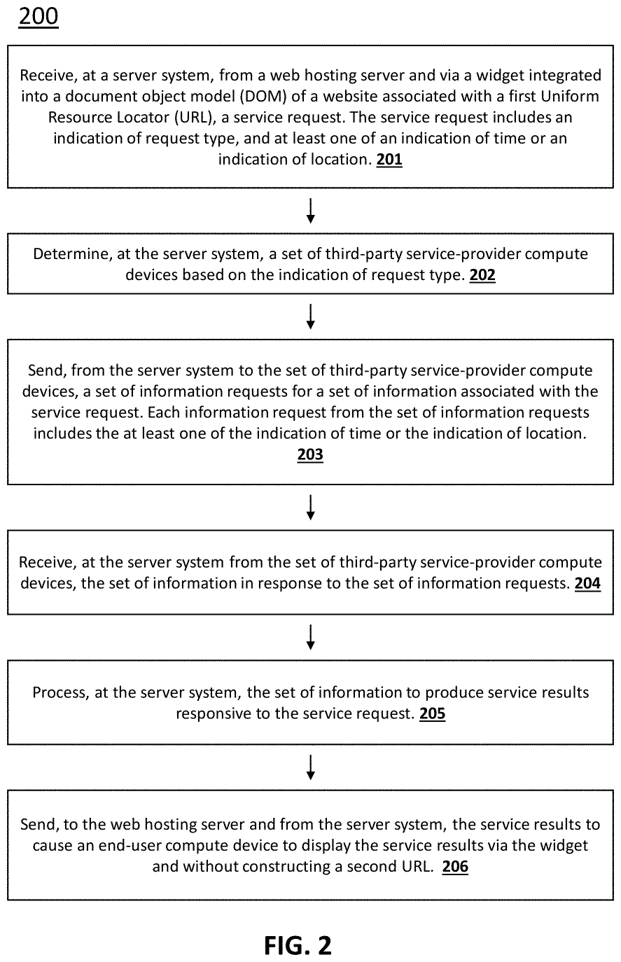

FIG. 2 is a flowchart of a method 200 of processing a service request and producing service results in response to the service request, according to an embodiment. In some implementations, a server system (such as the server system 130 as shown and described with respect to FIG. 1) can be used to perform the method 200. At 201, a service request is received at a server system from a web hosting server and via a widget integrated into a document object model (DOM) of a website associated with a first Uniform Resource Locator (URL). The service request includes an indication of request type, and at least one of an indication of time or an indication of location. In some instances, a webpage that includes a HyperText Markup Language (HTML) document and is associated with the first URL does not embed any additional HTML documents to the HTML document. In some instances, the webpage associated with the URL can include a Cascading Style Sheets (CSS) sandbox.

At 202, a set of third-party service-provider compute devices is determined, selected and/or identified, at the server system, based on the indication of request type. The indication of request type can include, for example, a flight search, a car rental search, a hotel search, an event search, a movie theater search, a taxi service search, a package search, a confirmation for availability of services, a confirmation for availability of venues, and/or the like. For example, when the indication of request type is indicative of a hotel search, third-party service-provider compute devices that have a functionality to search for hotels can be chosen as the set of third-party service-provider compute devices. At 203, a set of information requests is sent, from the server system to the set of third-party service-provider compute devices, for a set of information associated with the service request. Each information request from the set of information requests includes the at least one of the indication of time or the indication of location. In some implementations, the set of information requests can be labeled with a first time, when the set of information is generated by the server system and/or when transmitted to the set of third-party service-provider compute devices.

At 204, the set of information is received, at the server system from the set of third-party service-provider compute devices, in response to the set of information requests. Operation of the set of third-party service-provider compute devices is independent from the server system. Therefore, each third-party service-provider from the set of third-party service-provider compute devices can take any amount of time appropriate the set of information requests. For example, while a first third-party airline ticket search engine can take 100 milliseconds to generate and transmit information in response to an information request from the set of information requests, a second third-party airline ticket search engine can take 2 seconds to generate and transmit information in response to that information request.

In some implementations, the sever system can have a predetermined time-interval (e.g., 10 milliseconds, 50 milliseconds, 100 milliseconds, 500 milliseconds, 1 second, 5 seconds, etc.) stored in the memory of the server system, that can be used as a criterion for determining whether the server system should wait for a response from a third-party service-provider compute device from the set of third-party service-provider compute devices. The set of information can be received at a second set of times after the first time at the server system from the set of third-party service-provider compute devices. In some instances, when information from a third-party service-provider compute device is received at a second time from the second set of times and within the predetermined time-interval, the server system can store that information for further processing. In some instances, when information from a third-party service-provider compute device is received at a second time from the second set of times and after the predetermined time-interval, the server system can discard that information.

At 205, the set of information is processed, at the server system, to produce service results responsive to the service request. In some instances, the server system can filter the set of information to remove information that includes an error code. In one example, when the server system identifies one or more strings that are not meaningful (e.g., not found in one or more dictionaries) in information from the set of information, the server system can discard that information or send that information to the bottom of a list of the service results. In some implementations, the method 200 can further include ranking the set of information based on the service request to produce the service results responsive to the service request. In some instances, the set of information can be ranked by a machine learning model (e.g., supervised or unsupervised) that receives the set of information and generates ranked information. In some instances, the set of information can be ranked based on relevance to the search criteria. In one example, relevance to the search criteria can be measured by a distance of an information indicator from the service request indicator in a word embedding. At 206, the service results are sent, to the web hosting server and from the server system, to cause an end-user compute device to display the service results via the widget and without constructing a second URL and/or using an Inline Frame (IFrame). Not constructing a second URL, and consequently not loading an additional HTML document(s), can improve a customer search experience by returning the service results to the end-user compute device faster than known methods that use IFrames. In addition, multiple service results processed on a centralized server (e.g., the server system 130 as shown and described with respect to FIG. 1) can have the same or similar information formats, as described herein, and therefore, can be easier to read and/or compare for the user of the end-user compute device. Moreover, using the widget integrated into the programming interface can also reduce security risks associated with opening the additional HTML documents when using an IFrames which can, in some instances, load unexpected or undesirable elements to a user's device.

In some implementations, each third-party service-provider compute device from the set of third-party service-provider compute devices can provide information from the set of information in a different information format from a set of information formats. For example, in some instances, the set of information formats (e.g., a language(s), a unit(s), an encoding(s), etc.) can include any number (e.g., 5, 10, 20, 100, etc.) of information formats conventionally used by the set of third-party service-provider compute devices. The method 200 can further include standardizing the set of information received from the set of third-party service-provider compute devices. For example, in some instances, the server system can process the set of information based on an information shell to produce a set of standardized information. For example, the information shell can convert units of distances (e.g., meters, miles, etc.) in the set of information to kilometers. Thereafter, the service results can be generated/produced based on the set of standardized information.

In some implementations, the method 200 can further include sending, to a subset of third-party service-provider compute devices from the set of third-party service-provider compute devices and from the server system, nonpublic information (e.g., an airline loyalty identification number, membership number, account number, transaction information associated to a user of an end-user compute device, etc.) associated with the service request and the service results. In response, for example, the set of third-party service-provider compute devices can use the nonpublic information to provide more customized information (e.g., flight itinerary customized for the user's membership status). In some instances, the subset of third-party service-provider compute devices can be chosen based on a look-up table including a list of authorized third-party service-provider compute devices. In some instances, the subset of third-party service-provider compute devices can be selected randomly from the set of third-party service-provider compute devices. In some instances, the subset of third-party service-provider compute devices can be selected based on a set of criteria (e.g., information security criteria, membership criteria, etc.). In some instances, the server system can store a profile for the user of the end-user compute device, indicating past selections of the user based on the service results presented to the user. The past selections can be used by the server system, for future search request instances, to provide more relevant results to the user.

In some implementations, the method 200 can further include accessing a content developer network (CDN) to obtain a template for the widget. The server system can then be configured to cause (e.g., by sending a signal representing an operation command) the web hosting server and/or the end-user compute device to display (e.g., via a graphical user interface) the service results based on the template. The template can include a set of fields to display information. For example, in some instances, the template can include a first field to show a brand name, symbol, image, etc. of the third-party service-provider, a second filed to display a destination indicator(s), a third field to display a time indicator(s), a fourth field to display a cost indicator(s), and/or the like.

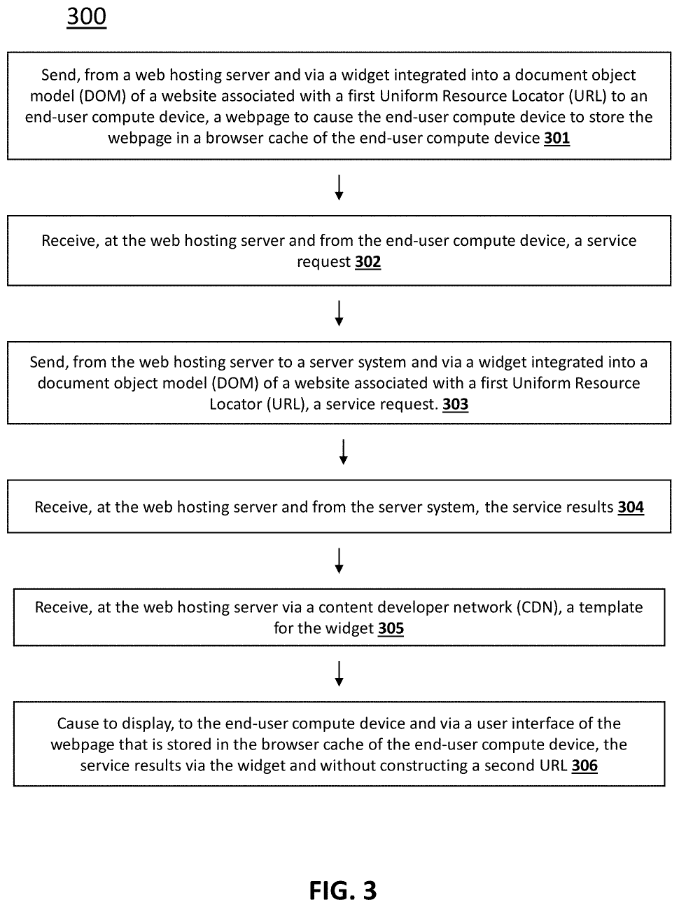

FIG. 3 is a flowchart of a method 300 of processing and presenting a service request via a widget integrated into a document object model (DOM) of a website, according to an embodiment. In some implementations, a web hosting server system (such as the web hosting server 105 as shown and described with respect to FIG. 1) can be used to perform the method 300. At 301, a webpage is sent, from a web hosting server and via a widget integrated into a document object model (DOM) of a website associated with a first Uniform Resource Locator (URL) to an end-user compute device, to cause the end-user compute device to store the webpage in a browser cache of the end-user compute device. At 302, a service request is received, at the web hosting server and from the end-user compute device. The service request can include and/or be associated with one or more keywords (e.g., search strings a user types via the end-user compute device), an indication of request type (e.g., flight search, car rental search, hotel search, etc.), and at least one of an indication of time (e.g., date, hour in a standard time zone, etc.) or an indication of location (e.g., a city name, a country name, etc.)

At 303, a service request is sent, from the web hosting server to a server system and via a widget integrated into a document object model (DOM) of a website associated with a first Uniform Resource Locator (URL). The service request includes an indication of request type, and at least one of an indication of time or an indication of location. The service request causes the server system to: (a) determine a set of third-party service-provider compute devices based on the indication of request type; (b) send, to the set of third-party service-provider compute devices, a set of information requests for a set of information associated with the service request, each information request from the set of information requests including at least one of the indication of time or the indication of location; (c) receive, from the set of third-party service-provider compute devices, the set of information in response to the set of information requests; and (d) process the set of information to produce service results responsive to the service request.

At 304, the service results are received at the web hosting server and from the server system. At 305, a template for the widget is received at the web hosting server via a content developer network (CDN). At 306, the service results are caused to display to the end-user compute device and via a user interface of the webpage that is stored in the browser cache of the end-user compute device via the widget and without constructing a second URL.

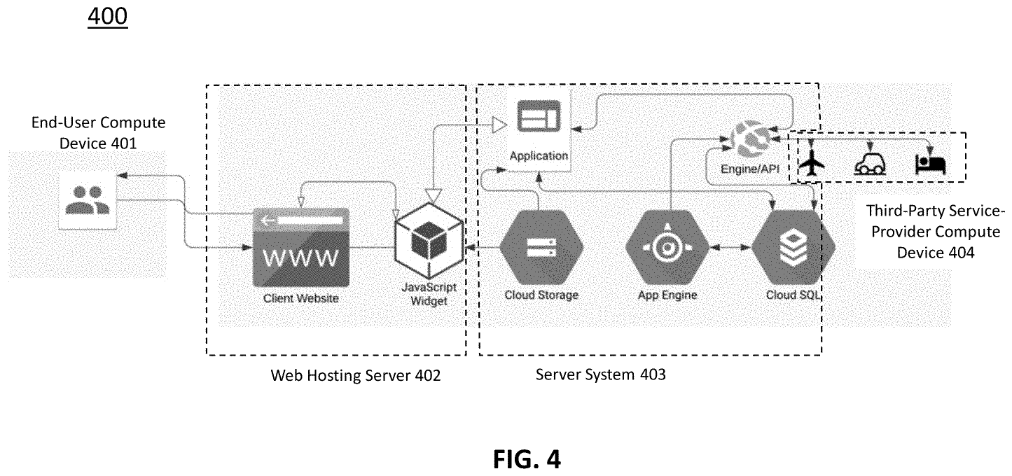

FIG. 4 is a flow diagram of processing a service request and producing service results in response to the service request in a service search environment 400 (similar to the service search environment 100 shown and described with respect to FIG. 1), according to an embodiment. The end-user compute device 401 can access, via a Uniform Resource Locator (URL), a webpage stored in a web hosting server 402. The webpage includes or is associated with a widget integrated into a document object model (DOM) of the webpage. The end user device can submit a service request (e.g., a flight search, an event search, etc.) using the widget of the webpage. The web hosting server 402 can then send the service request to a server system 403 via the widget integrated into the DOM of a website associated with a first Uniform Resource Locator (URL). The server system 403 can determine (e.g., using the application and/or the App Engine) a set of third-party service-provider compute devices 404 based on the indication of request type and from a superset of third-party service-provider compute devices (e.g., stored in cloud storage and/or cloud SQL). The server system 403 can then send a set of information requests for a set of information associated with the service request, via an application programming interface to the set of third-party service-provider compute devices 404. The set of third-party service-provider compute devices 404 can then send the set of information in response to the set of information requests to the server system 403. The server system 403 can then process the set of information to produce service results responsive to the service request and send the service results to the web hosting server 402 to cause the web hosting server 402 to display the service results on the end-user compute device 401. The web hosting server 402 can also obtain a template for the widget via a content developer network (CDN) and display the service results on the end-user compute device 401 based on the template, via the widget and without constructing a second URL.

In one example, the end user compute device 401 can access, via the URL (e.g., www.example.com), the webpage (including an HTML document with a widget) stored in the web hosting server 402. A user of the end user device can submit a hotel search request indicating a time interval (e.g., in August) and a desired location (e.g., Colorado). In addition, the user can also indicate a budget, a user profile including hotel loyalty memberships, and/or any other relevant information to the hotel search request. The web hosting server 402 can then send the hotel search request to the server system 403 via the widget integrated into the DOM of the website associated with the URL. The server system 403 can then determine the set of third-party service-provider compute devices 404 (e.g., including 5 hotel search engines) based on the hotel search request. The server system 403 can then send a set of information requests for availability and price of Hotel rooms in the desired location and the time interval. The set of third-party service-provider compute devices 404 can then send the set of information (e.g., a list of 100 hotel rooms with price and availability data) in response to the set of information requests, to the server system 403. The server system 403 can then process the set of information to produce service results (e.g., top 10 results from the 100 hotel rooms) responsive to the hotel search request. The web hosting server 402 can then display the service results to the user of the end-user compute device 401 based on the template.

In another example, the end-user compute device 401 can access the webpage stored in the web hosting server 402. The webpage can integrate the widget with a single line of code that can be used to access the widget's functionality. The user of the end-user compute device 401 can submit, for example, a health treatment request indicating a time interval (e.g., in March) and without an indication of desired hospital. In addition, the user can also indicate a medical condition associated to the health treatment request. The web hosting server 402 can then send the health treatment request to the server system 403 via the widget integrated into the DOM of the website associated with the URL. The server system 403 can then determine the set of third-party service-provider compute devices 404 (e.g., including 3 hospital search engines) based on the health treatment request. The server system 403 can then send a set of information requests for availability and price of health treatment at the time interval. The set of third-party service-provider compute devices 404 can then send the set of information (e.g., a list of 20 hospitals and 200 doctors with price and availability data) in response to the set of information requests, to the server system 403. The server system 403 can then process the set of information to produce service results (e.g., top 5 results from the list of 20 hospitals and 200 doctors) responsive to the health treatment request. The web hosting server 402 can then display the service results to the user of the end-user compute device 401 based on the template.

It should be understood that the disclosed embodiments are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. Thus, it is to be understood that other embodiments can be utilized, and functional, logical, operational, organizational, structural and/or topological modifications may be made without departing from the scope of the disclosure. As such, all examples and/or embodiments are deemed to be non-limiting throughout this disclosure.

Some embodiments described herein relate to methods. It should be understood that such methods can be computer implemented methods (e.g., instructions stored in memory and executed on processors). Where methods described above indicate certain events occurring in certain order, the ordering of certain events can be modified. Additionally, certain of the events can be performed repeatedly, concurrently in a parallel process when possible, as well as performed sequentially as described above. Furthermore, certain embodiments can omit one or more described events.

All definitions, as defined and used herein, should be understood to control over dictionary definitions, definitions in documents incorporated by reference, and/or ordinary meanings of the defined terms.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages, packages, and software development tools.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A non-transitory processor-readable medium storing code representing instructions to be executed by a processor, the code comprising code to cause the processor to:
receive, at a server system, from a web hosting server and via a widget integrated into a document object model (DOM) of a website associated with a first Uniform Resource Locator (URL), a service request that includes an indication of request type, a set of preferred service-providers, and at least one of an indication of time or an indication of location;
determine, at the server system, a set of third-party service-provider compute devices based on the indication of request type and the set of preferred service-providers;
send, from the server system to the set of third-party service-provider compute devices, a set of information requests for a set of information associated with the service request, each information request from the set of information requests including the at least one of the indication of time or the indication of location;
receive, at the server system from the set of third-party service-provider compute devices, the set of information in response to the set of information requests;
process, at the server system, the set of information to produce service results responsive to the service request; and
send, to the web hosting server and from the server system, the service results to cause an end-user compute device to display the service results via the widget and without constructing a second URL.

2. The non-transitory processor-readable medium of claim 1, further comprising code to cause the processor to:
rank, at the server system, the set of information based on the service request to produce the service results responsive to the service request.

3. The non-transitory processor-readable medium of claim 1, further comprising code to cause the processor to:
send, to a subset of third-party service-provider compute devices from the set of third-party service-provider compute devices and from the server system, nonpublic information associated with the service request and the service results.

4. The non-transitory processor-readable medium of claim 3, wherein the nonpublic information includes transaction information.

5. The non-transitory processor-readable medium of claim 1, further comprising code to cause the processor to:
store, at the server system and before determining the set of third-party service-provider compute devices, indications of a superset of third-party service-providers that include the set of third-party service providers.

6. The non-transitory processor-readable medium of claim 1, wherein each third-party service-provider compute device from the set of third-party service-provider compute devices provides information from the set of information in a different information format from a set of information formats.

7. The non-transitory processor-readable medium of claim 6, further comprising code to cause the processor to:
standardize the set of information received from the set of third-party service-provider compute devices, provided in the set of information formats, based on an information shell, to produce a set of standardized information; and
produce the service results based on the set of standardized information.

8. The non-transitory processor-readable medium of claim 1, further comprising code to cause the processor to:
send, from the server system to the set of third-party service-provider compute devices, the set of information requests at a first time; and
receive, at the server system from the set of third-party service-provider compute devices, the set of information at a second plurality of times after the first time and within a predetermined time-interval from the first time.

9. The non-transitory processor-readable medium of claim 8, further comprising code to cause the processor to:
receive, at the server system from the set of third-party service-provider compute devices, information other than the set of information at a third time after the first time, after the second plurality of times, and outside the predetermined time-interval from the first time; and
discard the information other than the set of information.

10. The non-transitory processor-readable medium of claim 1, wherein the service results are not displayed using an Inline Frame (IFrame).

11. The non-transitory processor-readable medium of claim 1, wherein a webpage associated with the first URL does not embed a first HyperText Markup Language (HTML) document to a second HTML document.

12. The non-transitory processor-readable medium of claim 1, wherein a webpage associated with the first URL includes a Cascading Style Sheets (CSS) sandbox.

13. The non-transitory processor-readable medium of claim 1, further comprising code to cause the processor to:
access a content developer network (CDN) to obtain a template for the widget, to cause the web hosting server to display the service results based on the template.

14. A method, comprising:
sending, from a server system to a set of third-party service-provider compute devices determined based on a set of preferred service-providers, a set of information requests for a set of information associated with a service request, each information request from the set of information requests including the at least one of an indication of time or an indication of location, the service request received at the server system from a web hosting server and via a widget integrated into a document object model (DOM) of a website associated with a first Uniform Resource Locator (URL) and, the service request including an indication of request type, a set of preferred service-providers, and at least one of an indication of time or an indication of location;
receiving, at the server system from the set of third-party service-provider compute devices, the set of information in response to the set of information requests;
processing, at the server system, the set of information to produce service results responsive to the service request;
accessing a content developer network (CDN) to obtain a template for the widget; and
sending, to the web hosting server, the service results to cause an end-user compute device to display the service results based on the template and without constructing a second URL.

15. The method of claim 14, further comprising:
sending, from the server system to the set of third-party service-provider compute devices, the set of information requests at a first time; and
receiving, at the server system from the set of third-party service-provider compute devices, the set of information at a second plurality of times after the first time and within a predetermined time-interval from the first time.

16. The method of claim 14, wherein the service results are not displayed using an Inline Frame (IFrame).

17. The method of claim 14, wherein a webpage associated with the first URL does not embed a first HyperText Markup Language (HTML) document to a second HTML document.

18. The method of claim 14, wherein a webpage associated with the first URL includes a Cascading Style Sheets (CSS) sandbox.

19. A method comprising:
sending, from a web hosting server and via a widget integrated into a document object model (DOM) of a website associated with a first Uniform Resource Locator (URL) to an end-user compute device, a webpage to cause the end-user compute device to store the webpage in a browser cache of the end-user compute device;
receiving, at the web hosting server and from the end-user compute device, a service request;
sending, from the web hosting server to a server system and via a widget integrated into a document object model (DOM) of a website associated with a first Uniform Resource Locator (URL), a service request that includes an indication of request type, a set of preferred service-providers, and at least one of an indication of time or an indication of location to cause the server system to:
determine a set of third-party service-provider compute devices based on the indication of request type and the set of preferred service-providers;
send, to the set of third-party service-provider compute devices, a set of information requests for a set of information associated with the service request, each information request from the set of information requests including at least one of the indication of time or the indication of location;
receive, from the set of third-party service-provider compute devices, the set of information in response to the set of information requests; and
process the set of information to produce service results responsive to the service request; and
receiving, at the web hosting server and from the server system, the service results;
receiving, at the web hosting server via a content developer network (CDN), a template for the widget; and
causing to display, to the end-user compute device and via a user interface of the webpage that is stored in the browser cache of the end-user compute device, the service results via the widget and without constructing a second URL.

20. The method of claim 19, wherein the service results are not displayed using an Inline Frame (IFrame).

21. The method of claim 19, wherein the webpage does not embed a first HyperText Markup Language (HTML) document to a second HTML document.
